(19) United States
(12) Patent Application Publication
(10) Pub. No.: US 2018/0015684 A1
(43) Pub. Date: Jan. 18, 2018

(54) CELL STRUCTURE FOR COMPOSITE SANDWICH CORE AND METHOD OF MAKING SANDWICH PANELS

(71) Applicant: Steven D. Lieberman, Oceanside, CA (US)

(72) Inventors: Steven D. Lieberman, Oceanside, CA (US); William C. Wight, San Diego, CA (US)

(21) Appl. No.: 15/546,238

(22) PCT Filed: Jun. 22, 2016
(86) PCT No.: PCT/US16/38742

§ 371 Date: Jul. 25, 2017

Related U.S. Application Data
(60) Provisional application No. 62/185,192, filed on Jun. 26, 2015.

(51) Int. Cl. B32B 3/12; B32B 15/04; B32B 5/02; B32B 5/26; B32B 27/12; B32B 15/14

(52) U.S. Cl. CPC B32B 3/12; B32B 27/12; B32B 15/14; B32B 5/02; B32B 5/26; B32B 15/04

(57) ABSTRACT

A core layer, a core cell and a method for making the core layer for a panel structure. The core layer includes multiple core cells, and a carrier fabric. The multiple core cells are bonded to the carrier fabric. A panel structure is made by situating between and bonding the core layer to a pair of face sheets. A core cell has multiple interconnected cross structures that each has two crossing struts. Each of the crossing struts has a first end and a second end. The first ends of each cross structure cross the first ends of an adjacent cross structure, and the second ends of each cross structure cross the second ends of an adjacent cross structure.

### CROSS-REFERENCE TO RELATED APPLICATIONS

This application claims the benefit of U.S. Provisional Application 62/185,192, titled “CORE CELL CONFIGURATION,” filed on Jun. 26, 2015, which is hereby incorporated by reference.

### BACKGROUND

### Field of the Invention

The invention relates to core structures for sandwich panels and a method of making composite sandwich core panels.

### Description of the Related Art

Core structures are used to make sandwich panels. These panels are used in various applications, such as wind turbine blades, vehicle panels, vehicle bulkheads and flooring. Laminates of glass or carbon fiber-reinforced thermoplastics or thermoset polymers may be used as skin materials of the composite sandwich panels. Open and closed cell foam, balsa wood, syntactic foams, and honeycombs are commonly used as the core materials in between layers of skin material. The application of core structures to wind turbine blades, and vehicle paneling, for example require panels with more strength and less weight at a lower manufacturing cost than heretofore possible.

There is a need for a core structure and a method for making a composite core sandwich that provides superior performance tuned toward the requirements of a specific application by, for example, an increased modulus, decreased density, increased strength, and/or a reduced cost.

### BRIEF SUMMARY OF THE INVENTION

The general purpose of the invention is to provide a core cell for a panel structure. The core cell has multiple cross-structures with each cross-structure having two crossing struts. The crossing struts have a first and a second end. The first ends of each of the multiple cross-structures cross the first ends of an adjacent cross-structure. The second ends of each cross-structure cross the second ends of an adjacent cross-structure. The interconnected cross-structures form a single cell of a core for a panel structure.

Multiple core cells are used in a core for a panel structure. A core layer includes multiple core cells and one or more pieces of carrier fabric, e.g., two pieces of carrier fabric. The multiple core cells are bonded to an inner surface of each of the one or more pieces of carrier fabric at the first and second ends of the struts. The angle at which the struts cross to form a cross structure may be increased or decreased, as required to obtain the desired shear and compression performance. The shear performance may be a shear strength or modulus and the compression performance may be a compression strength or modulus. The multiple core cells are placed between a pair of face sheets to form the composite sandwich panel. Foam may be injected between a pair of face sheets to surround the core cells. The core cells are scalable according to a desired thickness for the core layer.

The core layer for a panel structure is made by fabricating multiple core cells using automated tape laying, automated fiber placement or injection molding. The multiple core cells are placed into a matrix layer between the one or more pieces of carrier fabric and fused to the inner surface of the one or more pieces of carrier fabric by the first and second ends of the locked cross-structures in each cell.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a three-dimensional side perspective view of a core cell according to an aspect of the invention;

FIG. 2 is a two-dimensional side perspective view of a core cell with truss feet according to an aspect of the invention;

FIG. 3 is a three-dimensional side perspective view of a core cell with truss feet according to an aspect of the invention;

FIG. 4 is a two-dimensional top perspective view of a core cell according to an aspect of the invention;

FIG. 5 is a front perspective view of a core layer used for panel construction according to an aspect of the invention;

FIG. 6 is a front perspective view of a core layer with foam for panel construction according to an aspect of the invention;

FIG. 7 is an illustration of a top carrier fabric with conductive composite tape according to an aspect of the invention;

FIG. 8 is an illustration of a top carrier fabric with conductive paths and cuts according to an aspect of the invention;

FIG. 9 is an illustration of a bottom carrier fabric with conductive paths and cuts according to an aspect of the invention;

FIG. 10 is a flow chart of a process for fabricating a core layer for panel construction using automated tape laying or automated fiber placement according to an aspect of the invention; and

FIG. 11 is a flow chart of a process for fabricating the core layer for panel construction using injection molding according to an aspect of the invention.

Component parts shown in the drawings are not necessarily to scale, and may be exaggerated to better illustrate the important features of the present invention.

### DETAILED DESCRIPTION

A described core layer, a core cell, a core layer and a method for making a core layer for use in core panels is disclosed herein. Particular embodiments of the subject matter described in this specification may be implemented to realize one or more of the following advantages. The core layer optimizes mechanical performance for various attributes while minimizing density in comparison to existing cores. The optimization of the core attributes results in panels that are lighter, stiffer, cheaper and superior in performance than existing panels, using cores such as honeycomb or balsa wood, for example.

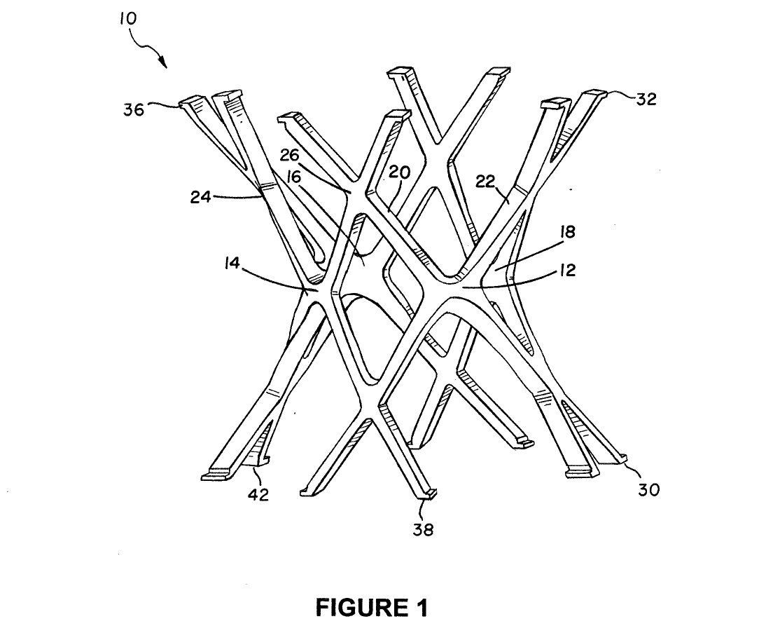

FIG. 1 is a core cell used for panel construction. The core cell 10 is optimized for mechanical performance independent of the material that the core cell 10 is made of. The core material is selected for a specific application and load condition. The core cell 10 may be made of a polymer, metal, composite, or any other material. The core cell 10 is usually compatible with any prepreg thermoplastic or thermoset face sheets. Freedom of material selection for the core cell 10 enables innovative designs where the core cell 10 delivers structural integrity and provides multifunctional proficiency.

The density, moduli, and/or strength of a core cell structure or panel are determined by a combination of the material selection, positioning of the core cells in an array, and the cross-sectional area, shape, and intersecting angles of the cross structures of the core cell 10. For example, alternatively spaced core cells made of carbon fiber composite have half the density of 5056 aluminum honeycomb cores, and equal or better mechanical performance. The core cell 10 is scalable in size, to achieve a variety of core thicknesses, and may be tailored for a particular load condition.

Given the same material, mechanical performance of a core cell 10 is approximately linearly proportional to the size of the core cell 10. The core cell 10 is scalable for a core height greater than 15 mm. As the size of the core cell 10 increases, the mechanical performance increases linearly. The scaling to a larger size core cell, however, does not linearly scale the bending properties of a panel constructed from a matrix of multiple core cells.

A core cell 10 has multiple interconnected cross-structures that are substantially similar in size and shape. The structure of the core cell 10 maximizes shear and compression moduli and/or strength of core layers. The cross-structures of the core cell 10 when placed into a matrix of multiple core cells provide open space in between, that allows additional material placement, or fluid movement for example. This allows for additional functions, such as air or fluid plenums, aerogel or foam-filled cavity for flotation, thermal or acoustic efficiency, ease of sensor placement for structural health monitoring, de-icing, lightning protection and fuel storage, for example. The open space may act as a plenum enabling warm air to circulate within the interior of a panel. By using the existing panel as an air duct, de-icing costs may be reduced.

Furthermore, the open space in the core cell matrix allows for adapting or changing the shape of a panel. The core cell 10 may be stiff under external loading and deformable under controlled conditions, for example. If a core cell 10 is made of shape-memory polymers and controlled stimuli are applied, the core cell 10 will alter in shape. The use of morphing core cells in a matrix will allow for adaptive core layers that may be used in airfoils or living hinges, for example. By using a single piece of carrier fabric, a core cell matrix has inherent flexibility to be contoured into complex geometries without scoring or cutting as required by balsa wood or other material, for example.

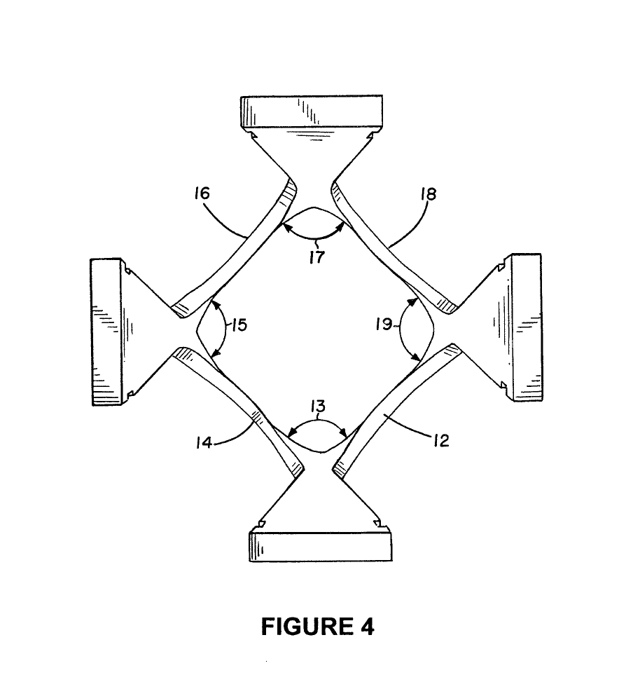

The multiple cross-structures of the core cell 10 are structurally connected to each other. As shown in FIG. 4, the core cell 10 has four interconnected cross-structures 12, 14, 16, and 18 that provide a closed perimeter. The core cell 10 is arranged in a substantially square configuration. Each cross-structure is positioned adjacent to two other cross-structures and opposite another cross-structure. Cross-structure 12 is positioned adjacent to cross-structures 14, 18 at angles 13, 19, respectively. Cross-structure 16 is positioned adjacent to cross-structures 14, 18 at angles 15, 17, respectively.

Cross-structures 12, 16 are opposite of each other while cross-structures 14, 18 are opposite of each other. The core cell 10 may have three, six or eight interconnected cross-structures arranged in a substantially triangular, hexagonal or octagonal configuration.

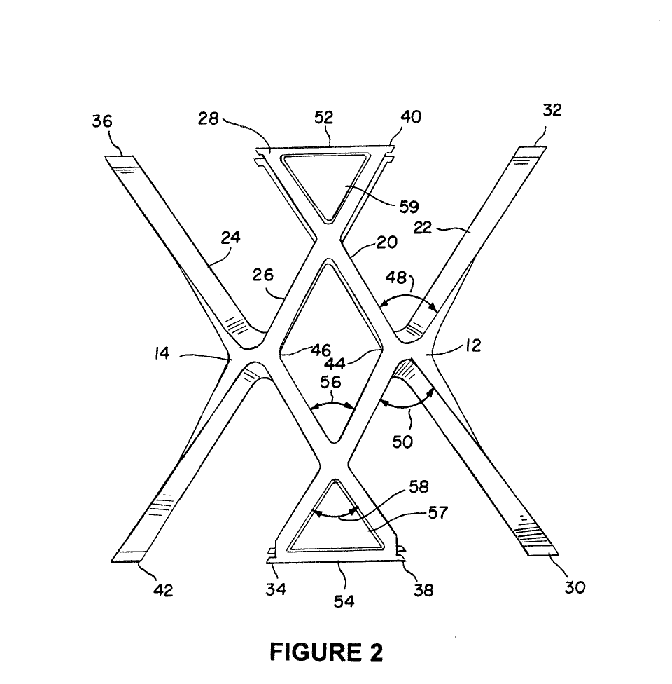

Each of the cross-structures 12, 14, 16 and 18 has two crossing struts. FIG. 2 shows a cross-structure 12 having struts 20, 22 and cross-structure 14 having struts 24, 26. The length of each strut is chosen for a specific application. Each of the struts has two ends, e.g., a first end 28 and a second end 30 for strut 20, a first end 32 and a second end 34 of strut 22, a first end 36 and a second end 38 for strut 24, and a first end 40 and a second end 42 for strut 26. The length of the struts determines the height of the core cell 10 and the thickness of a core layer.

The struts of each of the cross-structures intersect at their approximate middle to form the cross-structure. For example, the struts 20, 22 intersect at their approximate mid-length at connection point 44 to form cross-structure 12, and the struts 24, 26 intersect at their approximate mid-length at connection point 46 to form cross-structure 14. The struts of a cross-structure preferably intersect at a point that is at mid-length for each of the struts to form a symmetrical structure.

The first ends of the struts of a cross-structure need not be equidistant from the connection point. The length of a first end from the connection point may be greater than or less than the length of the second end from the connection point. If the length of the first ends of the struts are greater than the length of the second ends of the struts, the first ends of the struts will be farther apart than the second ends of the struts. If the length of the first ends of the struts are less than the length of the second ends of the struts, the second ends of the struts will be farther apart than the first ends of the struts.

The crossing of the struts of a cross-structure forms multiple angles surrounding the connection point that impact the shear and compression performance of the core cell 10. For example, the crossing of struts 20, 22 of cross-structure 12 creates a first angle 48 and a second angle 50 around connection point 44.

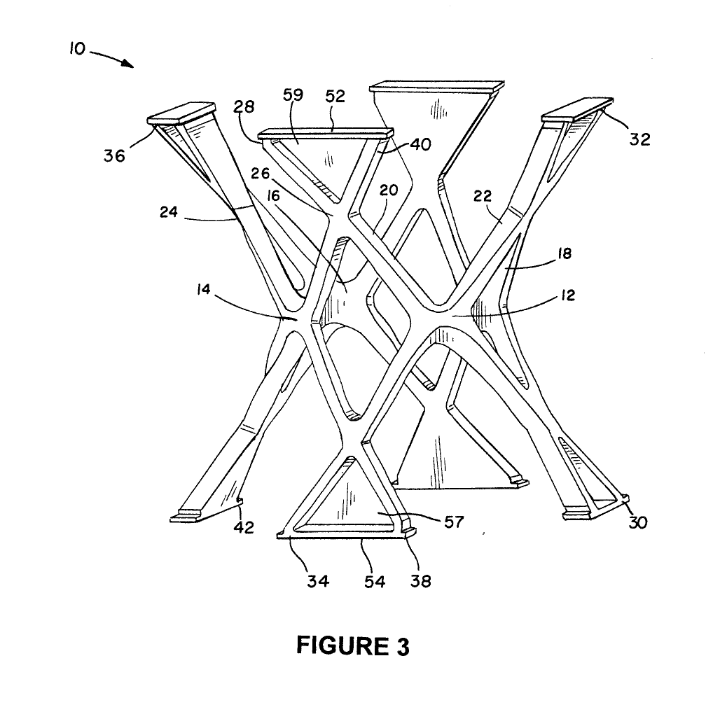

The first ends of the cross struts of each cross-structure cross and connect to the first ends of cross struts of adjacent cross-structures to form connected first truss feet. The second ends cross struts of each cross-structure cross and connect to the second ends of cross struts of adjacent cross-structures to form connected second truss feet. For example, strut 20 of cross-structure 12 intersects with strut 26 of cross-structure 14 at the first ends 28, 40 to form first truss foot 52. Strut 22 of cross-structure 12 intersects with strut 24 of cross-structure 14 at the second ends 34, 38 to form second truss foot 54. The truss feet 52, 54 may each have a panel insert 59, 57 that provides additional structural support, density and/or stability to the core cell 10. The truss feet 52, 54 may each be textured to increase the bonding strength of the core cell 10 to the panel face sheets. The core cell 10 with truss feet and panel inserts is shown in FIG. 3. The core cell 10 may not have truss feet or the panel inserts so that there is additional open space for additional material placement, or fluid movement, as shown in FIG. 1.

The truss feet may be over-molded with the same or different polymer than the material used for molding the core cell 10. Over-molding of the truss feet with material similar to the face sheets adds design flexibility since the core cells need not be made of the same thermoplastic material as the face sheets for melt-bonding attachments. By over-molding the truss feet with a polypropylene (PP) resin onto a polyamide (PA) core cell 10, the core cell 10 has the strength and stiffness of the PA but also the simplicity of attaching (e.g., melt-bonding) to PP face sheets, for example.

The crossing of the first ends and second ends of adjacent cross-structures forms a first truss foot and a second truss foot, respectively, of the core cell 10. The crossing of the first ends and the second ends of the adjacent cross-structures forms a first truss angle 56 and a second truss angle 58. Altering the angles of the cross-structures, such as first angle 48 and second angle 50 of cross-structure 12 will alter the first truss angle 56 and the second truss angle 58. Changing the angle will alter the compression performance, e.g., compression modulus and strength, and shear performance, e.g., shear modulus and strength, of the core cell 10. This allows for tailored mechanical performance of the core cell 10. Changing the cross sectional area of the cross-structures allows for changing the strength, stiffness, and density of the core cell 10.

A core cell 10 having maximum shear modulus and minimum density and cost may be obtained by adjusting the angles of the cross-structures of the core cell 10. Such core cell cores have superior performance to polypropylene honeycomb core and foam cores as attached in Table 1.

TABLE 1
T PLATES SANDWICH CORE COMPARISON

| | | | | Thermhex | |
|---|---|---|---|---|---|
| | Diab | Diab | Alrec | THPP60-FN | |
| | H45 | H60 | CS1 | polypropylene | T |
| | foam | foam | foam | honeycomb | Plates |
| Performance | core | core | core | core | core |
| Compression | 0.6 | 0.9 | 0.45 | 0.6 | 0.42 |
| Strength (Mpa) | | | | | |
| Compression | 50 | 70 | 25 | 15 | 32 |
| Modulus (Mpa) | | | | | |
| Shear Strength | 0.56 | 0.76 | 0.45 | 0.4-0.2 | 0.12 |
| (Mpa) | | | | | |
| Shear Modulus | 15 | 20 | 5 | 14-5 | 41 |
| (Mpa) | | | | | |
| Density (Kg/m³) | 48 | 60 | 60 | 60-70 | 36 |
| Cost | $$ | $$$ | $$$ | $ | $ |

The core cell of Table 1, has a shear modulus of 41 MPa. This is greater than that of the Diab H45 vinyl foam core, the Diab H60 vinyl foam core, the Airex C51 polyurethane foam core, and the Thermhex THPP60-FN polypropylene honeycomb core by more than double. At the same time, the density is almost half of the foam and honeycomb cores.

The first truss angle and the second truss angle of the cross-structures correlate with the shear strength and shear modulus of the core cell 10 and impact the compression modulus and compression strength of the core cell 10. For example, as the degree of the first truss angle 56 and the second truss angle 58 increases, the shear modulus and shear strength of the core cell 10 increases, while the compression modulus and the compression strength decrease. As the first truss angle 56 and the second truss angle 58 decrease, the shear modulus and shear strength of the core cell decrease while the compression modulus and the compression strength increase.

The first truss angle 56 and the second truss angle 58 may vary, from an angle greater than 0 degrees and less than or equal to 90 degrees. As the first truss angle 56 and the second truss angle 58 approach 0 degrees, the compression performance approaches a maximum and the shear performance approaches a minimum, and as the first truss angle 56 and the second truss angle 58 approach 90 degrees, the compression performance approaches a minimum and the shear performance approaches a maximum. When the first truss angle is at approximately 90 degrees, the struts 22, 24 are at approximately 45 degrees relative to a face sheet.

In some configurations, the degree of the first truss angle and the second truss angle are directly proportional to the shear strength and shear modulus of the core cell and are indirectly proportional to the maximum compression of the core cell. The degree of the first truss angle and the second truss angle are preferably substantially similar, but may differ slightly due to twisting of the struts.

In addition to affecting the shear and compression performance, the angle of the cross-structures correlates with the height of the core cell 10 and density of the core cell 10. As the first truss angle 56 and the second truss angle 58 increase the height decreases and the density decreases due to the longer cross-structures and as the first truss angle 56 and the second truss angle 58 decrease, the height and the density increase.

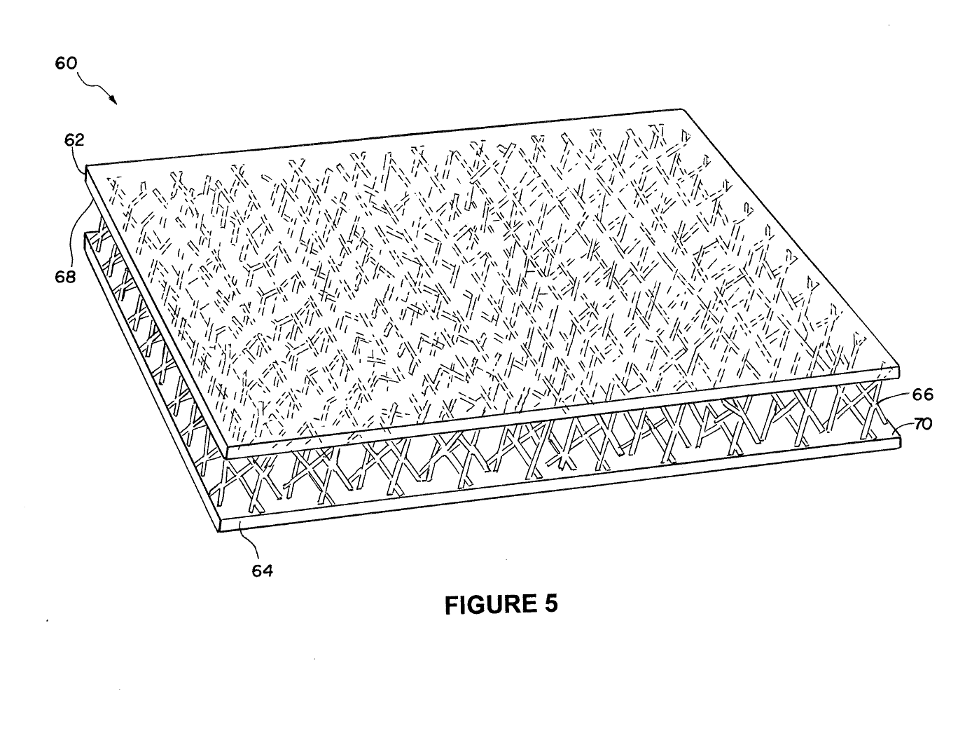

FIG. 5 shows an example of a core layer used for panel construction. The core layer 60 has a pair of face sheets 62, 64 and a matrix of core cells 66. The multiple core cells 66 are positioned between the pair of face sheets 62, 64. The pair of face sheets 62, 64 may be made of metal, thermoplastic or thermoset materials, with or without reinforcement, such as aluminum or fiberglass, for example.

The multiple core cells 66 are arranged between the pair of face sheets 62 in a density or pattern as determined for the particular application. The cores may be arranged in a rectangular matrix or in a selected pattern. Preferably the multiple core cells 66 of core layer 60 are arranged in a periodic array of adjacent core cells, such as in a matrix, with any number of core cells in a row and any number of core cells in a column of the periodic array. The number of core cells in a row may be the same or different from the number of core cells in a column. Either a square, or rectangular matrix for panel construction may be formed. The core cells may be arranged adjacent to one another or with an air gap in between one or more of the cells.

The multiple core cells 66 may also be arranged in a circular, non-periodic or other arrangement, for example. By selecting a combination of core cell 10 geometric configuration, thermoplastic matrix, reinforcing fiber, and cell spacing within the core layer, performance of the core panel is tuned for application requirements, such as modulus, density, fatigue resistance, impact strength, and cost, for example.

One or more substrates, such as a first piece of carrier fabric 68, or a second piece of carrier fabric 70, preferably interface between the multiple core cells 66 and face sheets 62, 64. The multiple core cells 66 are melt-bonded, adhesive bonded or thermally welded to the one or more pieces of carrier fabric. Each core cell 10 is bonded to a first piece of carrier fabric 68 and/or a second piece of carrier fabric 70 at distinct points, such as at a truss foot of the core cell 10. Each core cell 10 may remain unattached from an adjacent core cell in the matrix. The core cells 66 of the matrix which are bonded to an inner surface of the one or more pieces of carrier fabric 68, 70 may also be bonded to adjacent core cells.

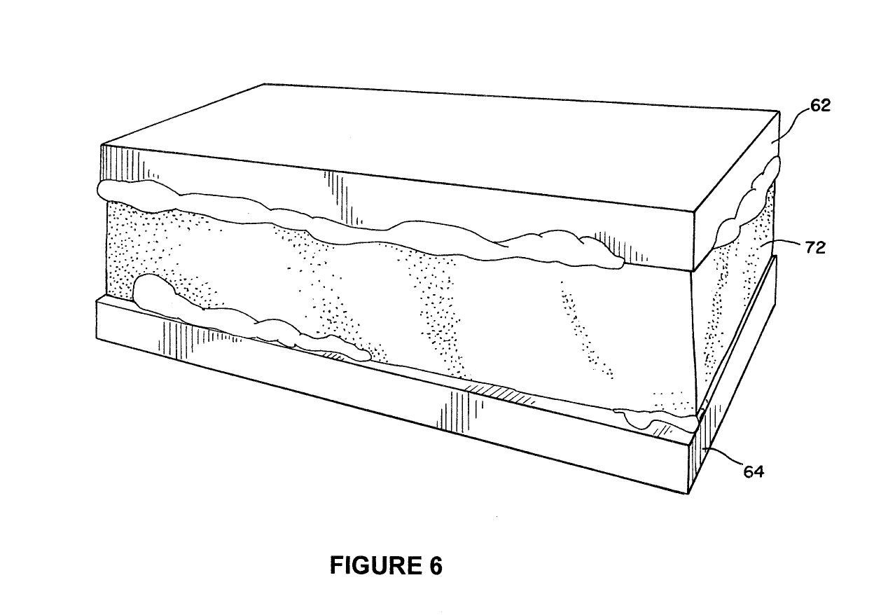

As shown in FIG. 6, foam 72 may be placed in between the face sheets between the core cells 66. The foam 72 surrounds each core cell 66 and provides support, and improves buckling resistance. The foam may be pour-in-place, closed cell, 2 lb./ft³ (32 kg/m³) polyurethane or other reinforced foam. The density of the foam may be controlled by automated processes to achieve 1.8-2.2. lb./ft³ (28.8-35.2 kg/m³).

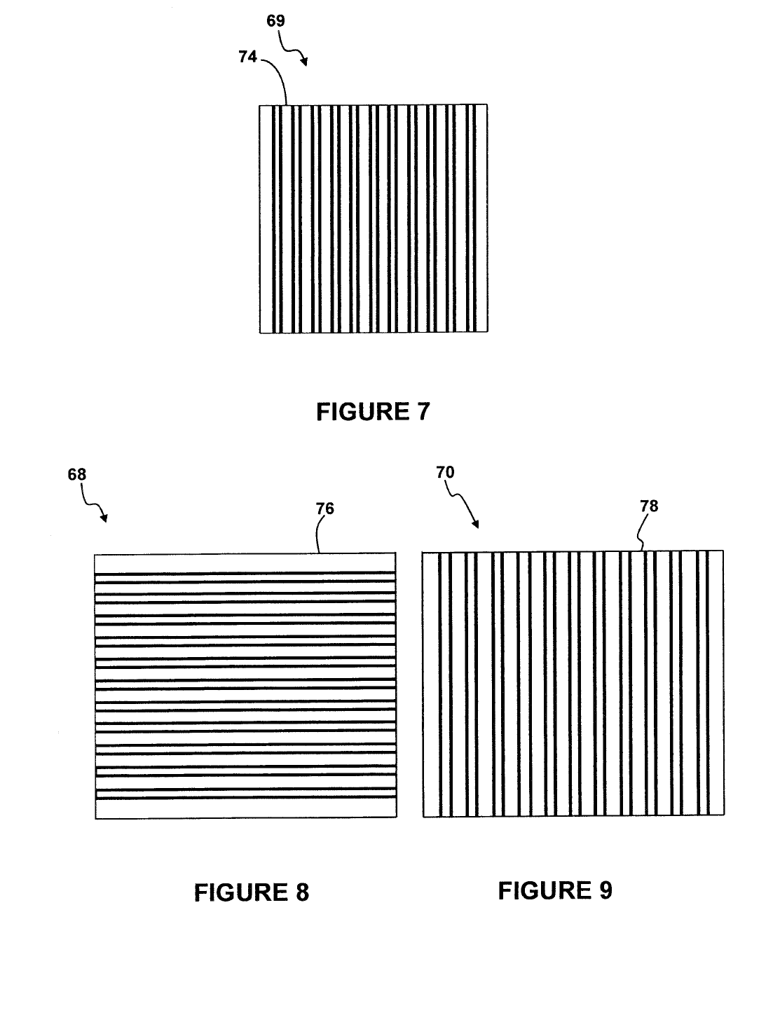

In some implementations, referring to FIG. 7, the core layer 60 may include a conductive composite tape 74 on the carrier fabric 69 that facilitates in-situ resistive welding of the multiple core cells 66. In some implementations, referring to FIGS. 8-9, the top and bottom carrier fabric 68, 70 may be cut 90 degrees out of phase to facilitate complex surface conformability. For example, the top carrier fabric 68 is cut horizontally in parallel with the conductive tape 76 and the bottom carrier fabric 70 is cut vertically in parallel with the conductive tape 78.

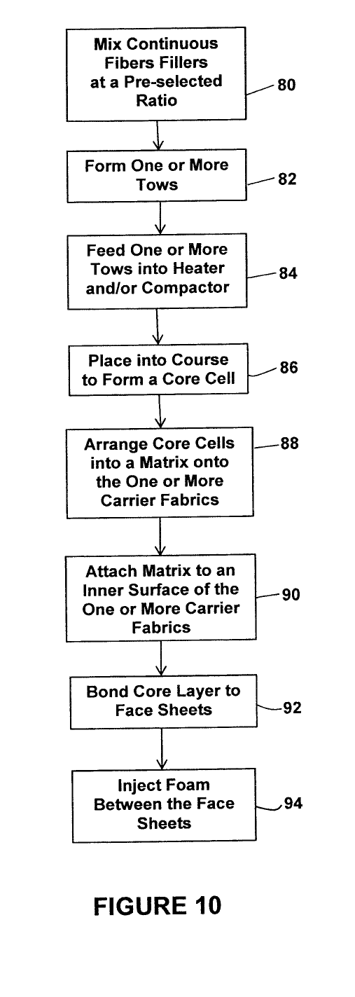

FIG. 10 shows an example of a process using automated tape laying or automated fiber placement for fabricating the core layer for panel construction. The fabrication system may make a core layer from an ordered cell array. The core cells 66 are generally manufactured in flat sheets or roll form. The sheets are typically 600 mm wide by 2400 mm long. For rolls, typical dimensions are 600 mm wide by a customer-defined length.

The fabrication system may mix the fiber fillers and resin at a pre-selected ratio to form a fiber material with continuous fiber strands (80). The fabrication system uses automated fiber placement or automated tape laying to fabricate multiple core cells from the fiber material. The fabricated multiple core cells are preferably made of a material, such as a polymer, a fiber composite or a metal, for example. The material is a continuous fiber, mostly-unidirectional fiber-reinforced composite that may have any percentage or ratio of fiber filler to resin, such as 60% fiber filler and 40% resin. The mixture may range from 0% fiber filler and 100% resin to 100% fiber filler and 0% resin.

When the fabrication system uses automated tape laying or automated fiber replacement to form the multiple core cells, the fabrication system forms one or more tows using the fiber material (82). The fabrication system feeds the one or more tows into a heater and/or compactor (84). The heater may heat the fiber material to a predetermined temperature and place the heated and/or compacted fiber material into a course to form a core cell (86).

The fabrication system arranges the multiple core cells into any pattern or shape on the one or more pieces of carrier fabric (88). The fabrication system may arrange the multiple core cells into a periodic ordered array, such as a matrix, on the inner surface of one or more pieces of carrier fabric. The matrix may have any number of rows and columns of core cells.

The multiple core cells are attached to an inner surface of the one or more pieces of carrier fabric (90). The core cells are attached or welded to the carrier fabric at one or more truss feet of each of the core cells. The core layer is bonded to the face sheets to form the sandwich panel (92). Foam may be injected between the face sheets and each core cell of the multiple core cells (94). The foam may be polyurethane foam.

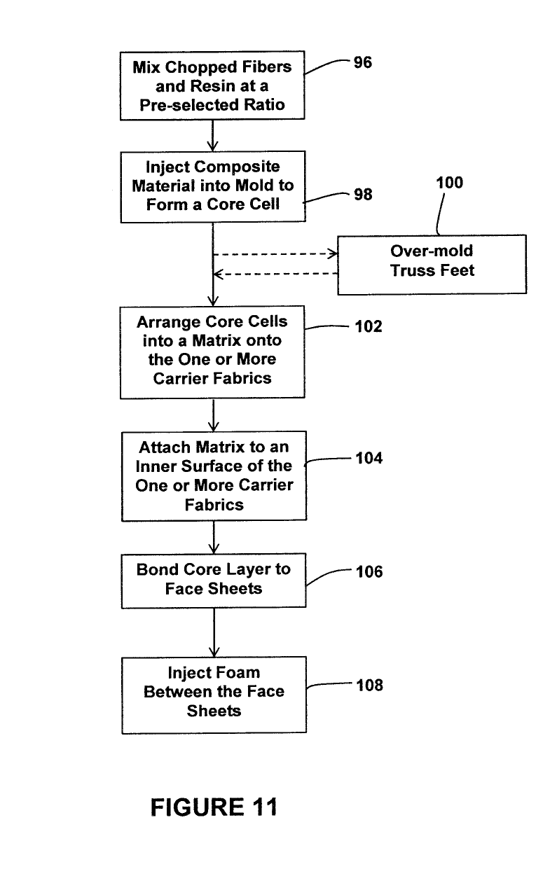

FIG. 11 shows an example of a process using injection molding for fabricating the core layer for panel construction. The fabrication system may mix the chopped fibers and resin at a pre-selected ratio to form a fiber material with chopped fiber strands (96). For injection molding, the fabrication system uses chopped fiber strands for reinforcement.

The fabricated multiple core cells are preferably made of a material, such as a polymer, a fiber composite or a metal, for example. The mixture may have any percentage or ratio of fiber filler to resin, such as 60% fiber fillers and 40% resin. The mixture may range from 0% fiber filler and 100% resin to 100% fiber filler and 0% resin.

When the fabrication system uses injection molding, the fiber material is injected into a mold to form a core cell (98). The fiber material is axially aligned with the orientation of the cross-structures of each of the core cells to maximize mechanical performance. By varying the cross sectional area and shape of the cross-structures of the core cells, the density, moduli and strength of the core layer can be controlled for the selected fiber material. Injection molding allows the use of a larger selection of composite materials which translates to more flexibility in optimizing density, mechanical performance, and cost of the core cell, for example.

The fabrication system may over-mold one or more truss feet of the core cell (100). The truss feet may be over-molded with the same or different material than the material used for the core cell.

The fabrication system arranges the multiple core cells into any pattern or shape on the one or more pieces of carrier fabric (102). The multiple core cells are attached to the inner surface of the one or more pieces of carrier fabric (104). The core cells are attached or welded to the carrier fabric at one or more truss feet of each of the core cells. The core layer is bonded to the face sheets to form the sandwich panel (106). Foam may be injected between the face sheets and each core cell of the multiple core cells (108).

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A core layer for a panel structure, comprising:
a pair of face sheets;
a plurality of core cells between the pair of face sheets, a respective core cell of the plurality of core cells having a plurality of interconnected cross-structures, each cross-structure having two cross struts, each cross strut having a first end and a second end, the first end of each cross strut of a cross-structure crossing the first end of a cross strut of an adjacent cross-structure, and the second end of each cross strut of the cross-structure crossing the second end of a cross strut of an adjacent cross-structure; and
a carrier fabric bonded to the plurality of core cells at the first end or the second end of each cross strut.

2. The core layer of claim 1, wherein the plurality of core cells is positioned in an array between the pair of face sheets and foam surrounds the plurality of core cells.

3. The core layer of claim 1, wherein the crossing of the first end of each cross strut of the cross-structure to the first end of the cross-strut of the adjacent cross-strut forms a truss foot, and has an angle that is configurable to increase or decrease to change at least one of a shear performance or a compression performance of the respective core cell.

4. The core layer of claim 3, wherein the truss foot has a panel insert.

5. The core layer of claim 3, wherein the shear performance is a shear strength or shear modulus and the compression performance is a compression strength or compression modulus.

6. A core cell for a panel structure, the core cell comprising:
a plurality of cross-structures, each cross-structure having two cross struts, each strut having a first end and a second end, the first ends of each cross strut of a cross-structure crossing the first ends of a cross strut of an adjacent cross structure, and the second ends of each cross strut of the cross-structure crossing the second ends of a cross strut of an adjacent cross-structure.

7. The core cell of claim 6, wherein the plurality of cross-structures include a first cross-structure, a second cross-structure, a third cross-structure and a fourth cross-structure, the first cross-structure being connected and adjacent to the second cross-structure and fourth cross-structure, and the third cross-structure being connected and adjacent to the second cross-structure and the fourth cross-structure.

8. The core cell of claim 7, wherein the first cross-structure includes:
a first end of a first cross-strut that crosses a first end of a second cross-strut of the second cross-structure,
a second end of a second cross-strut that crosses a second end of a first cross-strut of the second cross-structure,
a first end of a second cross-strut that crosses a first end of a first cross-strut of the fourth cross-structure, and
a second end of the first cross-strut that crosses a second end of a second cross-strut of the fourth cross-structure.

9. The core cell of claim 8, wherein the crossing of the first end of the first cross-strut and the first end of the second cross-strut of the cross-structure and the crossing of the second end of the second cross-strut and the second end of the first cross-strut of the second cross-structure each form a truss foot that interconnects the first cross-structure with the second cross-structure.

10. The core cell of claim 6, wherein the crossing of the first ends of each cross strut of the cross-structure to the first ends of the cross strut of the adjacent cross-structure forms a truss foot that has a panel insert.

11. The core cell of claim 10, wherein the core cell is made of a first material and the truss foot is over-molded with a second material.

12. The core cell of claim 6, wherein the core cell has three cross-structures, six cross-structures or eight cross-structures.

13. The core cell of claim 6, wherein the core cell is made of a shape-memory polymer.

14. A method for making a core layer for a panel structure, the method comprising:
fabricating a plurality of core cells using automated tape laying, automated fiber placement, or injection molding;
arranging a plurality of core cells into a matrix on one or more pieces of carrier fabric; and
attaching the matrix to an inner surface of each of the one or more pieces of carrier fabric.

15. The method of claim 14, wherein fabricating a plurality of core cells using automated fiber placement comprises:
feeding one or more tows including a plurality of fibers into a heater and a compactor; and
placing the one or more tows in one or more courses along a surface to fabricate a respective core cell of the plurality of core cells.

16. The method of claim 14, wherein fabricating a plurality of core cells using automated fiber placement further comprises:
forming a continuous-fiber composite from the one or more tows by mixing fiber fillers and resin to form the continuous-fiber composite, wherein the continuous-fiber composite is a mixture of 60% fiber fillers and 40% resin and the mixed fiber fillers and resin are formed into a continuous-fiber composite.

17. The method of claim 14, wherein attaching the matrix to the inner surface of each of the one or more pieces of carrier fabric includes welding each truss foot of each core cell of the plurality of core cells to the inner surface of the one or more pieces of carrier fabric.

18. The method of claim 14, further comprising:
injecting foam in between two face sheets so that the foam surrounds each core cell of the plurality of core cells.

19. The method of claim 14, wherein fabricating a plurality of core cells using injection molding includes injecting a chopped fiber composite into a mold of a core cell, wherein the chopped fiber composite is a mixture of fiber fillers and resin at a pre-selected ratio that ranges between 0% fiber filler and 100% resin to 100% fiber filler and 0% resin.

20. The method of claim 14, wherein fabricating the plurality of core cells using injection molding includes injecting a material into a mold to form a core cell that has one or more truss feet and over-molding the one or more truss feet of the core cell using a different material.
